(19) United States
(12) Patent Application Publication
(10) Pub. No.: US 2026/0098937 A1
(43) Pub. Date: Apr. 9, 2026

(54) TARGET DETECTION DEVICE

(71) Applicant: TOYOTA JIDOSHA KABUSHIKI KAISHA, Toyota-shi (JP)

(72) Inventor: Arata TAKADA, Toyota-shi (JP)

(73) Assignee: TOYOTA JIDOSHA KABUSHIKI KAISHA, Toyota-shi (JP)

(21) Appl. No.: 19/221,948

(22) Filed: May 29, 2025

(30) Foreign Application Priority Data
Oct. 4, 2024 (JP) 2024-175026

(51) Int. Cl. G01S 7/41; G01S 7/04; G01S 13/86; G01S 13/931

(52) U.S. Cl. CPC G01S 7/41; G01S 7/04; G01S 13/867; G01S 13/931; G01S 2013/93271; G01S 2013/93272; G01S 2013/93274

(57) ABSTRACT

A target detection device includes: a camera that detects a target existing in an imaging range around the host vehicle; a millimeter wave radar that detects a target existing in a measurement range including a region different from the imaging range around the host vehicle by a method different from the camera; a display unit that displays the target detected by the camera or the millimeter wave radar; a type determination unit that determines the type of the target detected by the camera; and a type estimation unit that estimates the type of the target detected by the millimeter wave radar based on the type determined by the type determination unit. The display unit displays the state of the target including the type determined by the type determination unit or the state of the target including the type estimated by the type estimation unit.

### CROSS-REFERENCE TO RELATED APPLICATION

This application claims priority to Japanese Patent Application No. 2024-175026 filed on Oct. 4, 2024. The disclosure of the above-identified application, including the specification, drawings, and claims, is incorporated by reference herein in its entirety.

### BACKGROUND

### 1. Technical Field

The present disclosure relates to a target detection device.

### 2. Description of Related Art

Japanese Unexamined Patent Application Publication No. 2022-41288 (JP 2022-41288 A), for example, describes an apparatus that acquires a traveling environment of a vehicle as peripheral information by an external sensor such as a camera. The apparatus generates an image to be displayed for confirmation of the status of a lane as the lane change destination. Further, the apparatus causes a display unit to display images of road lanes, the host vehicle, and other vehicles for confirmation of the status of the lane as the lane change destination.

### SUMMARY

In some cases, a target such as a different vehicle itself is detected by a different sensor in a state in which the target is outside the imaging range (detection range) of the camera. Even if the target is detected in such a manner, the type of the target cannot be displayed unless the type of the target can be determined, and therefore the type of the target may not be recognized in the above related art.

An object of the present disclosure is to provide a target detection device capable of recognizing the type of a target even in a state in which the target is outside the detection range of one sensor.

(1) According to an aspect of the present disclosure, there is provided a target detection device that detects a target existing around a host vehicle, the target detection device including:
a first sensor that detects a target existing in a first detection range around the host vehicle;
a second sensor that detects a target existing in a second detection range around the host vehicle by a method different from the first sensor, the second detection range including a region different from the first detection range;
a display unit that displays the target detected by the first sensor or the second sensor;
a type determination unit that determines a type of the target detected by the first sensor; and
a type estimation unit that estimates a type of the target detected by the second sensor based on the type of the target determined by the type determination unit, in which the display unit displays a state of the target including the type of the target determined by the type determination unit or a state of the target including the type of the target estimated by the type estimation unit.

(2) In (1) above,
the type estimation unit may estimate the type of the target detected by the second sensor based on the type of the target determined by the type determination unit when the target existing in the first detection range detected by the first sensor moves to the second detection range.

(3) In (1) or (2) above,
the target detection device may further include: a target information extraction unit that extracts information about the target detected by the first sensor; and
a storage unit that stores the type of the target determined by the type determination unit and the information about the target extracted by the target information extraction unit in association with each other, and
the type estimation unit may estimate the type of the target stored in the storage unit as the type of the target detected by the second sensor when information about the target detected by the second sensor coincides with the information about the target stored in the storage unit.

(4) In (3) above, the target detection device may further include
a stored information resetting unit that resets the type of the target and the information about the target stored in the storage unit when at least one of three conditions is not met, the three conditions including a state in which a target is detected by the second sensor, a state in which a target exists on a display screen of the display unit, and a state in which a time for which a type of the target and information about the target are stored in the storage unit is equal to or less than a prescribed time determined in advance.

According to the present disclosure, it is possible to recognize the type of a target even in a state in which the target is outside the detection range of one sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a driving assistance system including a target detection device according to an embodiment of the present disclosure;

FIG. 2 is a flowchart showing a procedure of a display control process executed by the display control unit shown in FIG. 1;

FIG. 3 is a flowchart showing a procedure of a stored data reset process executed by the stored data resetting unit shown in FIG. 1;

FIG. 4A is a schematic plan view showing an example of the scene which detects the target which exists in the circumference of self-vehicles with a target detection device

FIG. 4B is a schematic plan view illustrating an example of a configuration in which a target is detected by a target detection device;

FIG. 5A is a schematic plan view illustrating an exemplary scene for estimating the type of target detected by a millimeter-wave radar using target data stored in the target storage device shown in FIG. 1;

FIG. 5B is a schematic plan view illustrating another exemplary scene for estimating the type of target detected by the millimeter-wave radar using the target data stored in the target storage device shown in FIG. 1;

FIG. 5C is a schematic plan view illustrating another exemplary scene of estimating the type of target detected by the millimeter-wave radar using target data stored in the target storage device shown in FIG. 1; and

FIG. 5D is a schematic plan view illustrating another exemplary scene of estimating the type of target detected by the millimeter-wave radar using the target data stored in the target storage device shown in FIG. 1.

### DETAILED DESCRIPTION OF EMBODIMENTS

Hereinafter, embodiments of the present disclosure will be described in detail with reference to the drawings.

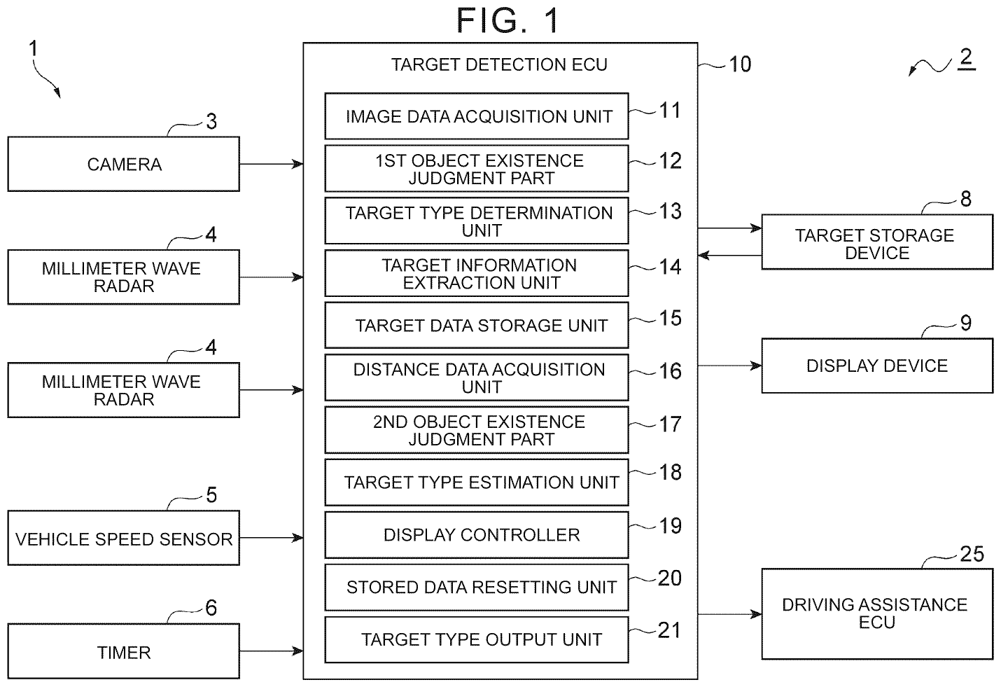

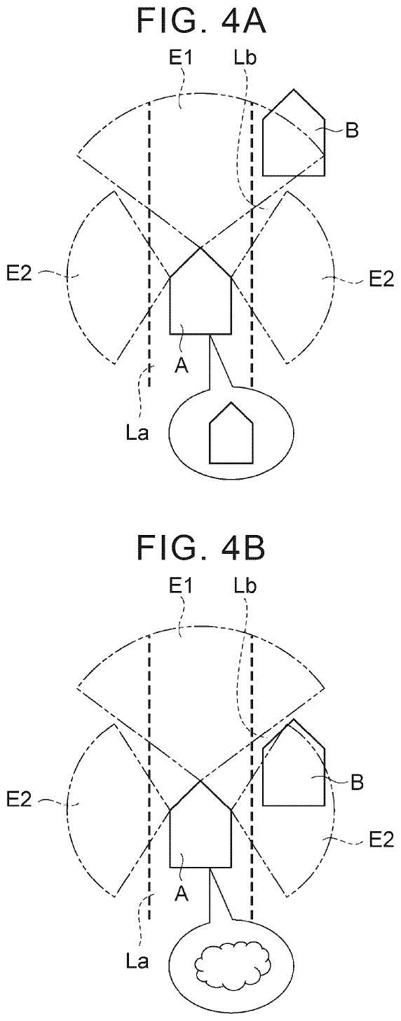

FIG. 1 is a schematic configuration diagram illustrating a driving assistance system including a target detection device according to an embodiment of the present disclosure. In FIG. 1, a target detection device 1 according to the present embodiment is provided in a driving assistance system 2 that supports driving of a host vehicle A (refer to FIGS. 4A, 4B). The driving assistance system 2 is mounted on the host vehicle A. The target detection device 1 is a device that detects a target existing around the host vehicle A.

The target detection device 1 includes a camera 3, a plurality of millimeter-wave radars 4, a vehicle speed sensor 5, a timer 6, a target storage device 8, a display device 9, and a target detection ECU 10 (Electronic Control Unit).

The camera 3 is disposed at a front portion of the host vehicle A. The camera 3 captures an image of the front side of the host vehicle A and acquires a captured image. The camera 3 detects a target object present in an imaging range E1 (refer to FIGS. 4A, 4B) in front of the host vehicle A. The camera 3 constitutes a first sensor that detects a target present in the imaging range E1 around the host vehicle A. Here, the target object is an object existing around the host vehicle A. As the camera 3, for example, a monocular camera, a stereo camera, or the like is used. The camera 3 is an image sensor capable of acquiring a target type (described later). The imaging range E1 of the camera 3 is, for example, an angular first sensing range smaller than 180 degrees.

The millimeter wave radar 4 is disposed on both sides of the host vehicle A. The millimeter wave radar 4 irradiates the radar in the millimeter wave band toward the side of the host vehicle A, and measures the distance to the target object existing on the side of the host vehicle A. The millimeter-wave radar 4 detects a target that is present in the measurement range E2 (refer to FIGS. 4A, 4B) on the side of the host vehicle A. The measurement range E2 of the millimeter-wave radar 4 differs from the imaging range E1 of the camera 3. The millimeter-wave radar 4 constitutes a second sensor that detects, by a method different from the camera 3, a target object existing in the measurement range E2 including an area different from the imaging range E1 of the camera 3 around the host vehicle A. The measurement range E2 of the millimeter-wave radar 4 is, for example, an angular second detection range smaller than 180 degrees.

The vehicle speed sensor 5 is a sensor that detects a traveling speed (vehicle speed) of the host vehicle A. The timer 6 measures time. The timer 6 may be built in the target detection ECU 10.

In the target storage device 8, the type of the target and the information on the target are stored in association with each other. The type of the target object is, for example, a vehicle other than the host vehicle A (another vehicle), a two-wheeled vehicle, a bicycle, a person, or another obstacle. Examples of the type of the target include a passenger car, a truck, a bus, and the like in another vehicle. Examples of the target object include a vehicle case (sedan, SUV, wagon, and the like) of another vehicle, a relative velocity of the other vehicle with respect to the host vehicle A, and features of the other vehicle (spoiler, wing, and the like). Note that the information on the type of the target and the target is collectively referred to as target data.

The display device 9 is disposed on an instrument panel disposed at a front portion of the driver's seat. The display device 9 displays information related to target detection and driving assistance. The information related to target detection and driving assistance includes targets detected by the camera 3 and the millimeter wave radar 4.

The display device 9 displays the state of the target detected by the camera 3 and the millimeter wave radar 4 as the information related to the target detection. The state of the target includes the type of the target, the position and attitude of the target with respect to the host vehicle A, and the like. The display device 9 displays, for example, a target object together with the host vehicle A in a renderable area on the display screen. The display device 9 displays the target object together with the host vehicle A in an image in a renderable area on a display screen, for example, so that the driver of the host vehicle A can recognize the type of the target object.

The target detection ECU 10 includes a CPU, RAM, ROM, an input/output interface, and the like. The target detection ECU 10 loads a program recorded in ROM into RAM, for example, and executes the program loaded in RAM in CPU.

The target detection ECU 10 includes an image data acquisition unit 11, a first target presence/absence determination unit 12, a target type determination unit 13, a target information extraction unit 14, a target data storage unit 15, and a distance data acquisition unit 16. Further, the target detection ECU 10 includes a second target presence/absence determination unit 17, a target type estimation unit 18, a display control unit 19, a stored data resetting unit 20, and a target type output unit 21.

The image data acquisition unit 11 acquires image data in front of the host vehicle A, which is obtained by imaging by the camera 3.

Based on the image data of the camera 3 acquired by the image data acquisition unit 11, the first target presence/absence determination unit 12 determines whether or not a target is present in the imaging range E1 (refer to FIGS. 4A, 4B) of the camera 3.

The target type determination unit 13 determines the type of the target when the first target presence/absence determination unit 12 determines that the target exists within the imaging range E1 of the camera 3. The type of the target is as described above. The target type determination unit 13 cooperates with the image data acquisition unit 11 and the first target presence/absence determination unit 12 to constitute a type determination unit that determines the type of the target detected by the camera 3.

When the first target presence/absence determination unit 12 determines that a target exists within the imaging range E1 of the camera 3, the target information extraction unit 14 extracts information on the target based on the image data of the camera 3 and the detected value of the vehicle speed sensor 5. The information on the target is as described above. The detection value of the vehicle speed sensor 5 is used for calculating the relative speed of the target with respect to the host vehicle A together with the image data of the camera 3.

The target data storage unit 15 stores the type of the target determined by the target type determination unit 13 and the information related to the target extracted by the target information extraction unit 14 in the target storage device 8 in association with each other. When the target data storage unit 15 stores the target data, which is information about the type of the target and the target, in the target storage device 8, the timer 6 measures the storage time of the target data.

The target storage device 8 and the target data storage unit 15 constitute a storage unit that stores the type of the target determined by the target type determination unit 13 and the information related to the target extracted by the target information extraction unit 14 in association with each other.

The distance data acquisition unit 16 acquires distance data from the host vehicle A to the target, which is obtained by measurement by the millimeter wave radar 4.

The second target presence/absence determination unit 17 determines whether or not a target is present in the measurement range E2 (refer to FIGS. 4A, 4B) of the millimeter-wave radar 4 based on the distance data from the host vehicle A to the target acquired by the distance data acquisition unit 16.

When the second target presence/absence determination unit 17 determines that a target exists within the measurement range E2 of the millimeter wave radar 4, the target type estimation unit 18 estimates the type of the target detected by the millimeter wave radar 4 based on the type of the target determined by the target type determination unit 13. The type of the target is as described above.

The target type estimation unit 18 cooperates with the distance data acquisition unit 16 and the second target presence/absence determination unit 17 to configure a type estimation unit that estimates the type of the target detected by the millimeter wave radar 4 based on the type of the target determined by the type determination unit.

The target type estimation unit 18 estimates the type of the target detected by the millimeter wave radar 4 on the basis of the type of the target determined by the target type determination unit 13 when the target existing in the imaging range E1 detected by the camera 3 moves in the measurement range E2.

Specifically, the information about the target detected by the millimeter wave radar 4 may coincide with the information about the target stored in the target storage device 8. In this case, the target type estimation unit 18 estimates the type of the target stored in the target storage device 8 as the type of the target detected by the millimeter wave radar 4.

The display control unit 19 causes the display device 9 to display the target object detected by the camera 3 or the millimeter wave radar 4. The display control unit 19 causes the display device 9 to display the state of the target including the type of the target determined by the target type determination unit 13 or the state of the target including the type of the target estimated by the target type estimation unit 18.

The display device 9 and the display control unit 19 constitute a display unit that displays a target detected by the camera 3 or the millimeter wave radar 4. The display unit displays a state of the target including the type of the target determined by the target type determination unit 13 or a state of the target including the type of the target estimated by the target type estimation unit 18.

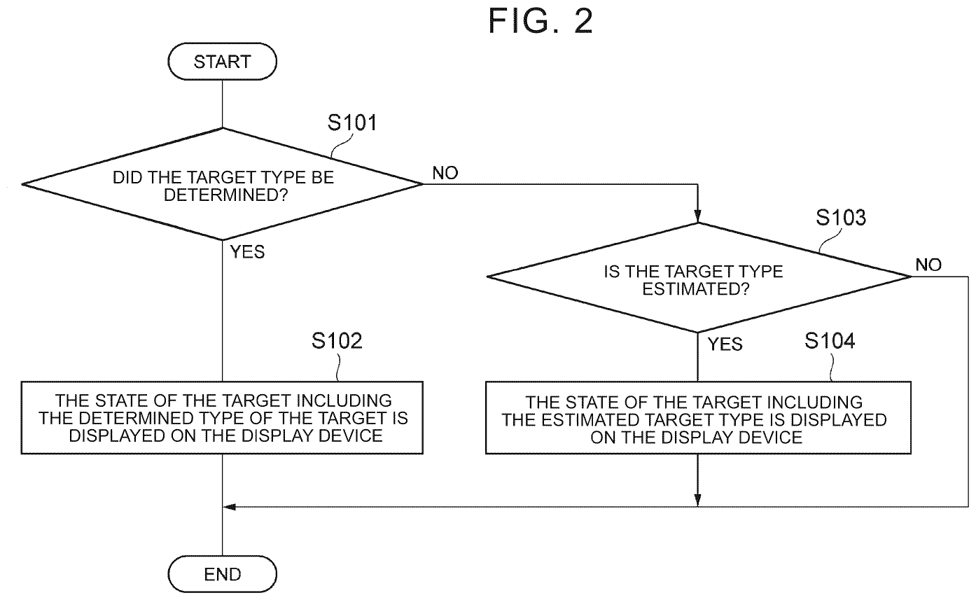

FIG. 2 is a flowchart illustrating a procedure of a display control process executed by the display control unit 19.

In FIG. 2, the display control unit 19 first determines whether or not the target type determination unit 13 determines the type of the target (step S101). When determining that the type of the target is determined, the display control unit 19 causes the display device 9 to display the status of the target including the determined type of the target (step S102).

When determining that the type of the target is not determined, the display control unit 19 determines whether or not the type of the target is estimated by the target type estimation unit 18 (step S103). When determining that the type of the target is estimated, the display control unit 19 causes the display device 9 to display the status of the target including the estimated type of the target (step S104).

When determining that the type of the target is not estimated, the display control unit 19 does not execute the above-described steps S102, S104.

Returning to FIG. 1, when at least one of the three conditions of the first state, the second state, and the third state is not satisfied, the stored data resetting unit 20 resets the information on the type of the target and the target stored in the target storage device 8. The first state is a state in which a target is detected by the millimeter wave radar 4. The second state is a state in which a target is present on the display screen of the display device 9. The third state is a state in which the time in which the information on the type of the target and the target is stored in the target storage device 8 is equal to or less than a prescribed time determined in advance.

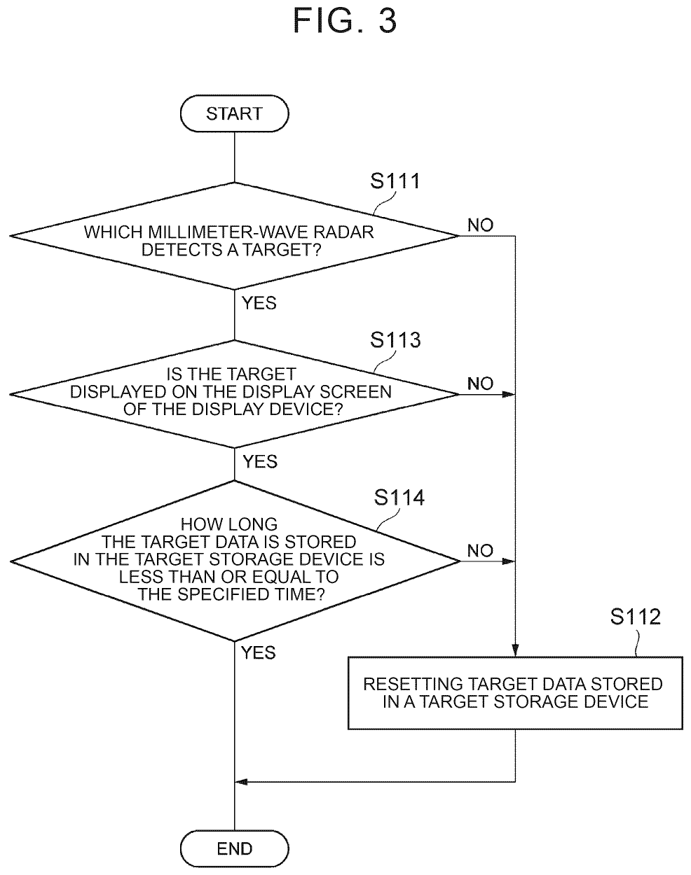

FIG. 3 is a flowchart illustrating a procedure of a stored data reset process executed by the stored data resetting unit 20.

In FIG. 3, the stored data resetting unit 20 first determines whether or not a target is in the measurement-range E2 (see FIGS. 4A and 4B) of any of the millimeter-wave radars 4 by the second target presence/absence determination unit 17 (step S111). That is, the stored data resetting unit 20 determines whether or not a target is detected by any of the millimeter wave radars 4.

When the stored data resetting unit 20 determines that the target is not within the measurement range E2 of any of the millimeter-wave radars 4, it resets the storage data of the target storage device 8 (step S112). Here, the stored data of the target storage device 8 is target data that is information about the type of target and the target. That is, the stored data resetting unit 20 deletes the target data stored in the target storage device 8.

When the stored data resetting unit 20 determines that the target is in the measurement range E2 of any of the millimeter-wave radars 4, the display control unit 19 determines whether the target is in the renderable area on the display screen of the display device 9 (step S113).

When determining that the target is not displayed in the renderable area on the display screen of the display device 9, the stored data resetting unit 20 resets the target data stored in the target storage device 8 (step S112).

When determining that the target is displayed in the renderable area on the display screen of the display device 9, the stored data resetting unit 20 determines whether the time period in which the target data is stored in the target storage device 8 is equal to or less than a predetermined time period (step S114). The determination of whether the time during which the target data is stored in the target storage device 8 is less than or equal to a predetermined time is based on the measurement time of the timer 6.

When determining that the time period in which the target data is stored in the target storage device 8 is not equal to or less than the specified time period, the stored data resetting unit 20 resets the target data stored in the target storage device 8 (step S112).

When the stored data resetting unit 20 determines that the time period in which the target data is stored in the target storage device 8 is less than or equal to the specified time period, it does not execute the procedural S112.

Returning to FIG. 1, the target type output unit 21 outputs the type of the target determined by the target type determination unit 13 or the type of the target estimated by the target type estimation unit 18 to the driving assistance ECU 25.

The driving assistance ECU 25 controls each unit of the host vehicle A to perform steering assistance and acceleration/deceleration assistance of the host vehicle A in accordance with the type information of the target output from the target type output unit 21.

In the driving assistance system 2 including the target detection device 1 as described above, when the other vehicle B is traveling in the lane Lb as shown in FIG. 4A, the other vehicle B is detected by the camera 3 when the other vehicle B is within the imaging range E1. The lane Lb is a lane adjacent to the lane La on which the host vehicle A travels. The imaging range E1 is an imaging range of the camera 3 in front of the host vehicle A. At this time, the camera 3 detects the type of the other vehicle B.

Then, the state of the other vehicle B detected by the camera 3 is displayed on the display screen of the display device 9. Further, the type information of the other vehicle B detected by the camera 3 is sent to the driving assistance ECU 25, and the driving assistance of the host vehicle A according to the type information of the other vehicle B is performed in the driving assistance ECU 25.

In addition, the type of the other vehicle B is associated with information related to the other vehicle B, such as the vehicle rank of the other vehicle B, the relative speed of the other vehicle B with respect to the host vehicle A, and the characteristics of the other vehicle B, and the like, and the information is stored in the target storage device 8.

Thereafter, as shown in FIG. 4B, when the vehicle speed of the other vehicle B decreases with respect to the vehicle speed of the host vehicle A, the host vehicle A approaches the other vehicle B. Then, the other vehicle B is out of the imaging range E1 of the camera 3, and the other vehicle B enters the host vehicle A within the measurement range E2 of the millimeter-wave radar 4 on the side. Therefore, the other vehicle B is not detected by the camera 3, but the other vehicle B is detected by the millimeter wave radar 4. However, the millimeter wave radar 4 cannot directly detect the type of the other vehicle B. On the other hand, the vehicle rank and features of the other vehicle B can be detected by the millimeter wave radar 4.

Therefore, the type of the other vehicle B is estimated by associating the vehicle case, the feature, and the like of the other vehicle B detected by the millimeter wave radar 4 with the type of the other vehicle B and the information on the other vehicle B stored in the target storage device 8. Specifically, the vehicle rank, the characteristic, and the like of the other vehicle B detected by the millimeter wave radar 4 may coincide with the information about the other vehicle B stored in the target storage device 8. In this case, the type of the other vehicle B stored in the target storage device 8 is estimated as the type of the other vehicle B detected by the millimeter wave radar 4.

Then, the state of the other vehicle B estimated from the distance data of the millimeter wave radar 4 is displayed on the display screen of the display device 9. Further, the distance data of the millimeter-wave radar 4 and the type information of the other vehicles B estimated based on the target data stored in the target storage device 8 are sent to the driving assistance ECU 25. Then, in the driving assistance ECU 25, the driving assistance of the host vehicle A according to the type data of the other vehicle B is performed.

As described above, in the present embodiment, the target object present in the imaging range E1 around the host vehicle A is detected by the camera 3. At the same time, the millimeter-wave radar 4 detects a target object present in the measurement range E2 including an area that differs from the imaging range E1 around the host vehicle A. Then, the type of the target detected by the camera 3 is determined, and the type of the target detected by the millimeter wave radar 4 is estimated based on the type of the target. Then, the state of the target including the determined or estimated type of the target is displayed. Specifically, in a state in which the target is included in the imaging range E1 of the camera 3, the state of the target including the type of the determined target is displayed. When the target is deviated from the imaging range E1 of the camera 3, the state of the target including the estimated type of the target is displayed in a state in which the type of the target is not determined. The type of the target is recognized even when the target deviates from the imaging range E1 of the camera 3 in this way.

Further, in the present embodiment, when the target object present in the imaging range E1 detected by the camera 3 moves in the measurement range E2 of the millimeter wave radar 4, the type of the target object detected by the millimeter wave radar 4 is estimated based on the determined type of the target object. Therefore, the type of the target that has moved from within the imaging range E1 of the camera 3 to within the measurement range E2 of the millimeter-wave radar 4 can be reliably estimated. Therefore, even when the target is deviated from the imaging range E1 of the camera 3, the type of the target is accurately recognized.

Further, in the present embodiment, the information on the target detected by the camera 3 is extracted, and the determined type of the target and the extracted information on the target are stored in the target storage device 8 in association with each other. When the information on the target detected by the millimeter wave radar 4 matches the information on the target stored in the target storage device 8, the type of the target stored in the target storage device 8 is estimated as the type of the target detected by the millimeter wave radar 4. In this way, it is determined whether or not the information on the target detected by the millimeter wave radar 4 matches the information on the target detected by the camera 3 and stored in the target storage device 8, and the type of the target detected by the millimeter wave radar 4 is estimated. Therefore, even when the target is deviated from the imaging range E1 of the camera 3, the type of the target is recognized with higher accuracy.

Further, in the present embodiment, when at least one of the three conditions of the first state, the second state, and the third state is not satisfied, the information on the type of the target and the target stored in the target storage device 8 is reset. The first state is a state in which a target is detected by the millimeter wave radar 4. The second state is a state in which a target is present on the display screen of the display device 9. The third state is a state in which the time period in which the information on the type of the target and the target is stored in the target storage device 8 is equal to or less than the predetermined time period. As described above, by resetting the type of the target and the information on the target stored in the target storage device 8 as necessary, for example, continuous display of an unnecessary image is suppressed. In addition, an inexpensive memory having a small capacity can be used as the target storage device 8.

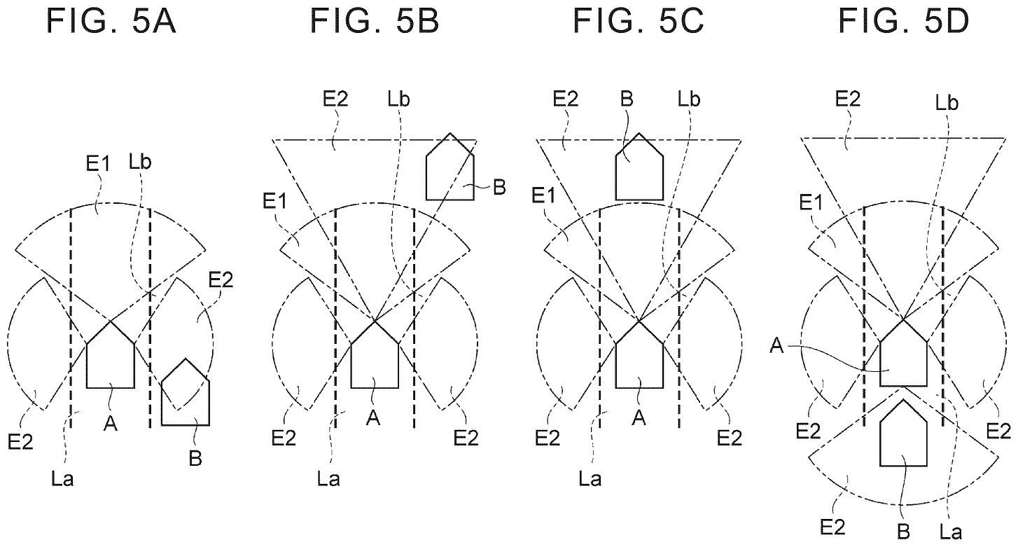

FIGS. 5A, 5B, 5C, 5D are each a schematic plan view illustrating an example in which the type of the target detected by the millimeter-wave radar 4 is estimated using the target data stored in the target storage device 8.

In FIG. 5A, even if the other vehicle B moves backward with respect to the host vehicle A from the condition shown in FIG. 4B, the other vehicle B is included in the measurement range E2 of the millimeter-wave radar 4 disposed on the side portion of the host vehicle A.

In FIG. 5B, the millimeter-wave radar 4 is also disposed at the front portion of the host vehicle A, and the other vehicle B is included in the measurement range E2 of the millimeter-wave radar 4 disposed at the front portion of the host vehicle A. In the scene shown in FIG. 5B, the vehicle speed of the other vehicle B is higher than the vehicle speed of the host vehicle A from the state shown in FIG. 4A, so that the other vehicle B travels ahead of the host vehicle A in the lane Lb adjacent to the lane La on which the host vehicle A travels.

In FIG. 5C, the millimeter wave radar 4 is also disposed at the front portion of the host vehicle A, and the other vehicle B is included in the measurement range E2 of the millimeter wave radar 4 disposed at the front portion of the host vehicle A. In the scenario shown in FIG. 5C, the other vehicle B travels ahead of the host vehicle A in the lane La in which the host vehicle A travels.

In FIG. 5D, the millimeter-wave radar 4 is disposed at the front and the rear of the host vehicle A, and the other vehicle B is included in the measurement range E2 of the millimeter-wave radar 4 disposed at the rear of the host vehicle A. In the scenario shown in FIG. 5D, the other vehicle B travels behind the host vehicle A in the lane La in which the host vehicle A travels.

Note that the present disclosure is not limited to the above-described embodiment. For example, in the above-described embodiment, the type of the target detected by the camera 3 is determined, and the type of the target detected by the millimeter wave radar 4 is estimated based on the type of the target. For example, instead of the camera 3, a laser sensor such as a LiDAR that can acquire the type of the target object may be used as the first sensor. Instead of the millimeter-wave radar 4, a sonar or the like that cannot acquire the type of the target but is inexpensive may be used as the second sensor.

The driving assistance system 2 of the above-described embodiment includes the target detection ECU 10 and the driving assistance ECU 25, but is not particularly limited to this configuration, and the target detection function and the driving assistance function may be realized by one ECU.

Further, although the target detection device 1 of the above-described embodiment is included in the driving assistance system 2, the present disclosure is also applicable to a vehicle that is not equipped with the driving assistance system.

What is claimed is:

1. A target detection device that detects a target existing around a host vehicle, the target detection device comprising:
a first sensor that detects a target existing in a first detection range around the host vehicle;
a second sensor that detects a target existing in a second detection range around the host vehicle by a method different from the first sensor, the second detection range including a region different from the first detection range;
a display unit that displays the target detected by the first sensor or the second sensor;
a type determination unit that determines a type of the target detected by the first sensor; and
a type estimation unit that estimates a type of the target detected by the second sensor based on the type of the target determined by the type determination unit, wherein the display unit displays a state of the target including the type of the target determined by the type determination unit or a state of the target including the type of the target estimated by the type estimation unit.

2. The target detection device according to claim 1, wherein the type estimation unit estimates the type of the target detected by the second sensor based on the type of the target determined by the type determination unit when the target existing in the first detection range detected by the first sensor moves to the second detection range.

3. The target detection device according to claim 1, further comprising:
a target information extraction unit that extracts information about the target detected by the first sensor; and
a storage unit that stores the type of the target determined by the type determination unit and the information about the target extracted by the target information extraction unit in association with each other, wherein
the type estimation unit estimates the type of the target stored in the storage unit as the type of the target detected by the second sensor when information about the target detected by the second sensor coincides with the information about the target stored in the storage unit.

4. The target detection device according to claim 3, further comprising a stored data resetting unit that resets the type of the target and the information about the target stored in the storage unit when at least one of three conditions is not met, the three conditions including a state in which a target is detected by the second sensor, a state in which a target exists on a display screen of the display unit, and a state in which a time for which a type of the target and information about the target are stored in the storage unit is equal to or less than a prescribed time determined in advance.
